(19) United States
(12) Patent Application Publication
(10) Pub. No.: US 2007/0084126 A1
(43) Pub. Date: Apr. 19, 2007

(54) Door or gate

(75) Inventors: Dieter Hautmann, Schwarzenbach (DE); Jurgen Hofmann, Tauperlitz (DE); Oliver Sommer, Hof/Saale (DE)

Correspondence Address: SUGHRUE MION, PLLC, 2100 PENNSYLVANIA AVENUE, N.W., SUITE 800, WASHINGTON, DC, 20037, US

(73) Assignee: SOMMER METALLBAU-STAHLBAU GMBH & CO. KG

(21) Appl. No.: 11/545,673

(22) Filed: Oct. 11, 2006

(30) Foreign Application Priority Data
Oct. 11, 2005 (DE) 10 2005 048 701.7

(51) Int. Cl. E06B 7/16

(52) U.S. Cl. 49/483.1

(57) ABSTRACT

Door or gate, with an at least partially peripheral sealing means, with a retaining strip made from metal, within which the seal is arranged, wherein the seal may be activated pneumatically and is provided in the region of a door or gate opening for air-tight abutment against an installation frame made from metal, with fastening means arranged laterally of the seal for fastening electrically conductive contact elements, the electrical contact elements extending in the direction of the longitudinal axis of the seal and with their end above the surface of the seal that is directed toward the door or gate opening in such a way that when the door/gate is closed, said contact elements are pressed into electrical contact with the building-side installation frame and the surface of the seal is at the same time in air-tight contact with the installation frame.

The invention relates to a door or a gate comprising an at least partially peripheral sealing means.

Various buildings, including hospitals, have to be protected from electromagnetic pulses (EMP) in order to shield equipment from external influences.

An electromagnetic pulse is a very short but extremely powerful electromagnetic wave. The currents induced in electrically conductive material can destroy electrical or electronic devices. Such powerful electromagnetic pulses may, for example, be generated by lightning or atomic bombs.

On explosion of an atomic bomb, the fission and decay processes produce gamma radiation. The gamma radiation affects the surrounding molecules and atoms by the Compton effect. Electrons released by the Compton effect move away from the centre of the explosion at high speed, whereas the ionised atoms are able to move only slowly. As a result of this charge separation, a powerful electromagnetic field is briefly built up. This field soon collapses, as the positively charged ions and electrons in the field start to move toward one another again.

Although the powerful electromagnetic field exists only very briefly, its effects can be serious. The very fact that the field collapses so quickly means that high voltages may be produced in electrically conductive materials. Moreover, as the fields spread at the speed of light, it is also not possible to alert regions that may be affected. The voltages and currents that are produced destroy electrical devices such as transformers, telephone lines, computers or the like, unless they are appropriately shielded.

A distinction is drawn between LEMP (lightning electromagnetic pulses), HEMP (high electromagnetic pulses) and NEMP (nuclear electromagnetic pulses) depending on the cause or the intensity of the electromagnetic pulse generated.

LEMP protective measures are standardised in DIN V V DI V 0185, Part 4 and HEMP protective measures are standardised in DIN EN 61000-2-9.

In order to protect buildings or rooms from high-frequency electromagnetic pulses, buildings are provided with an electrically conductive fabric having a mesh as required. The entry regions, i.e. the door and gate regions, are however problematic, as when the door or gate is closed, these regions are also intended to ensure shielding from electromagnetic pulses.

The object of the invention is therefore to provide a door or a gate allowing reliable protection of an opening in a building from high-frequency electromagnetic pulses and/or electromagnetic fields.

In accordance with the invention, this object is achieved by the following features:

Door or gate, with an at least partially peripheral sealing means, with a retaining strip made from metal, within which the seal is arranged, wherein the seal may be activated pneumatically and is provided in the region of a door or gate opening for air-tight abutment against an installation frame made from metal, with fastening means arranged laterally of the seal for fastening electrically conductive contact elements, the electrical contact elements extending in the direction of the longitudinal axis of the seal and with their end above the surface of the seal that is directed toward the door or gate opening in such a way that when the door/gate is closed, said contact elements are pressed into electrical contact with the building-side installation frame and the surface of the seal is at the same time in air-tight contact with the installation frame.

According to one embodiment the seal has a base with foot portions which extend laterally away from the base and are clamped to the retaining strip.

According to a further embodiment the spring contact strips fastened on both sides of the seal are provided as the electrical contact elements.

According to a further embodiment the retaining strip comprises a clamping strip which may be fastened to an L-shaped recess in the retaining strip so as to enclose the seal.

According to a further embodiment the retaining strip comprises a substantially U-shaped groove into which the seal is inserted so as to be enclosed by clamping strips.

According to a further embodiment the retaining strip and the clamping strip are provided with grooves formed in the surface of said strips and in that the grooves are provided with an electrically conductive fabric into which ends of the spring contacts are pressed.

According to a further embodiment the grooves are covered by strips so as to enclose the spring contacts.

According to a further embodiment the spring contacts have hook-shaped or circular bent-over ends and in the ends are arranged above the adjustable face of the seal.

According to a further embodiment the clamping strip, which may be fastened to the retaining strip, comprises a groove which is directed toward the retaining strip and into which there is inserted an electrically conductive fabric which may be brought into contact with the strip.

According to a further embodiment the adjustable sealing portion is provided on its surface with ribs, channels or teeth.

According to a further embodiment the seal is fastened to the retaining strip by clamping strips.

According to a further embodiment the seal is provided with lateral grooves or slots which extend in the axial direction and are provided above the foot portions and in the retaining strip and the clamping strip are provided with ribs or projections which engage with the grooves in the seal.

According to a further embodiment the clamping strip is provided so as to face the centre of the door or the gate.

According to a further embodiment the spring contacts consist of a continuous strip extending substantially below the clamping strips whereas the tongues of the spring contacts, which are arranged above the seal, are provided with slots.

According to a further embodiment the hook-shaped or bent ends of the spring contacts are set apart from a centre line of the seal and from one another.

According to a further embodiment the spring contacts are slotted, at least in part, transversely to the longitudinal axis of the seal.

The arrangement described hereinafter with reference to a gate or a door may in principle be used in revolving doors, sliding gates and revolving gates. In accordance with the invention, shielding from high-frequency electromagnetic pulses is ensured in that there are provided in the region of a pneumatically acting seal spring elements which, on the one hand, are connected to the door or gate-plate so as to conduct electricity effectively and, on the other hand, are pressed, owing to the effect of the pneumatic seal when the door or the gate is closed, against the electrically conductive installation frame attached on the building side.

The invention provides a pneumatic seal for doors or gates, in particular revolving or sliding gates and revolving doors, with a strip for receiving a pneumatically actuatable sealing element with grooves formed in the strip laterally of the sealing element for receiving electrically conductive fabric and with clamping strips arranged laterally of the sealing element for fixing spring contacts, the free ends of which are arranged above the sealing element.

According to an embodiment the sealing element comprises foot portions which are overlapped by stand portions of the strip.

According to a further embodiment the sealing element comprises slots which extend substantially parallel to the base and with which the ribs of the strip engage.

According to a further embodiment the strip comprises clamping strips which are fastened by screwing means and which support foot portions of the sealing element.

In order to explain further features, preferred embodiments of the gate according to the invention will be described hereinafter with reference to the drawings, in which:

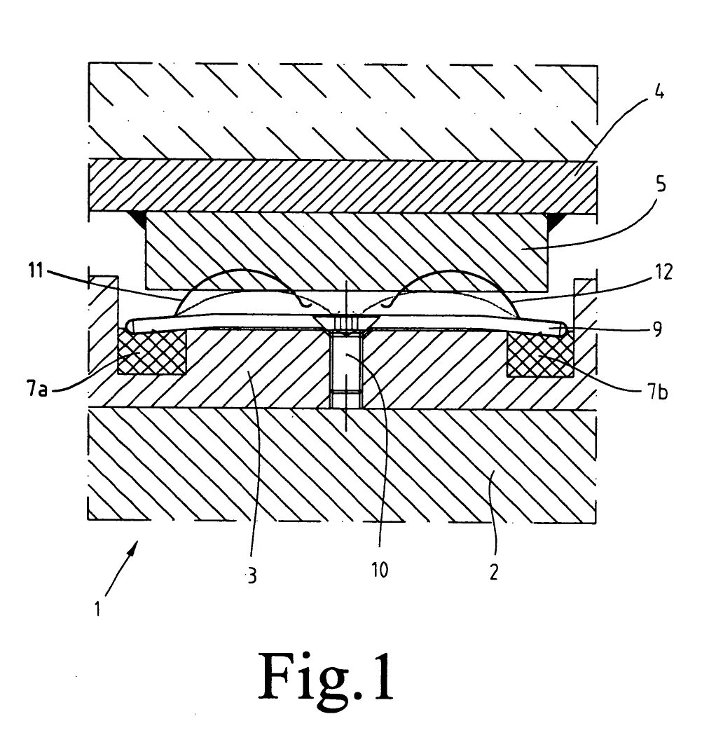

FIG. 1 is a schematic illustration of a known arrangement with electrically conductive spring contacts;

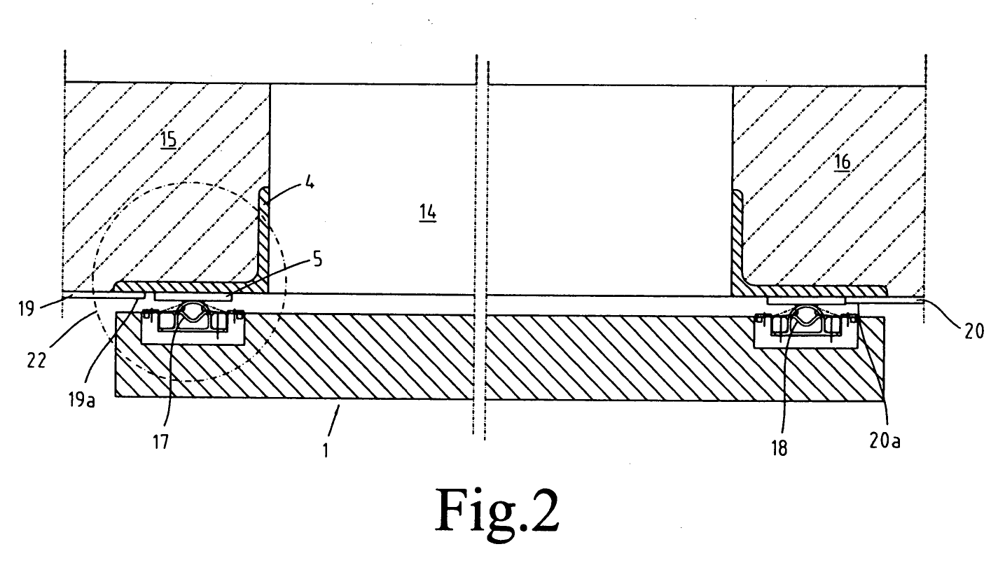

FIG. 2 is a schematic illustration of a gate relative to an opening in a building according to the invention;

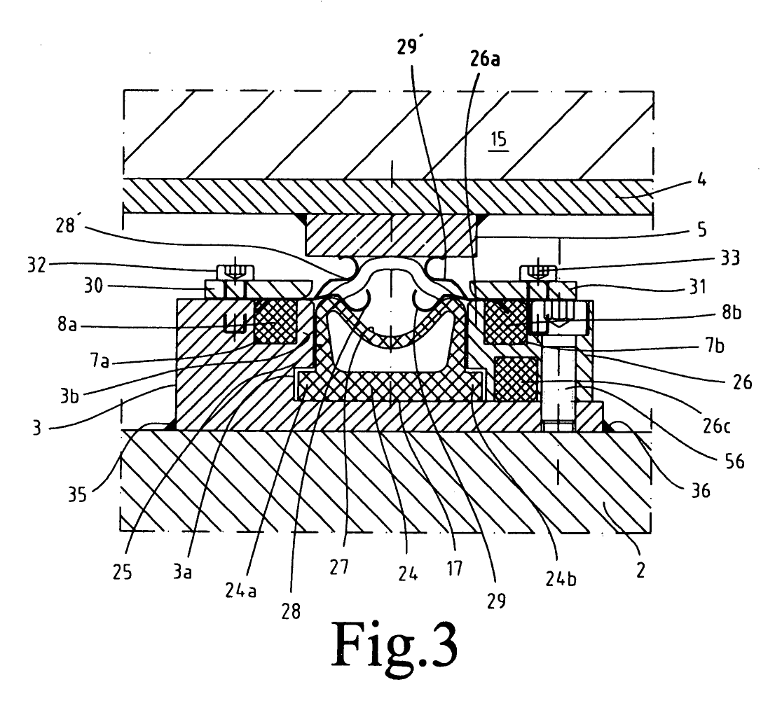

FIG. 3 is a detailed view of the arrangement according to the invention of the pneumatic seal relative to a revolving door;

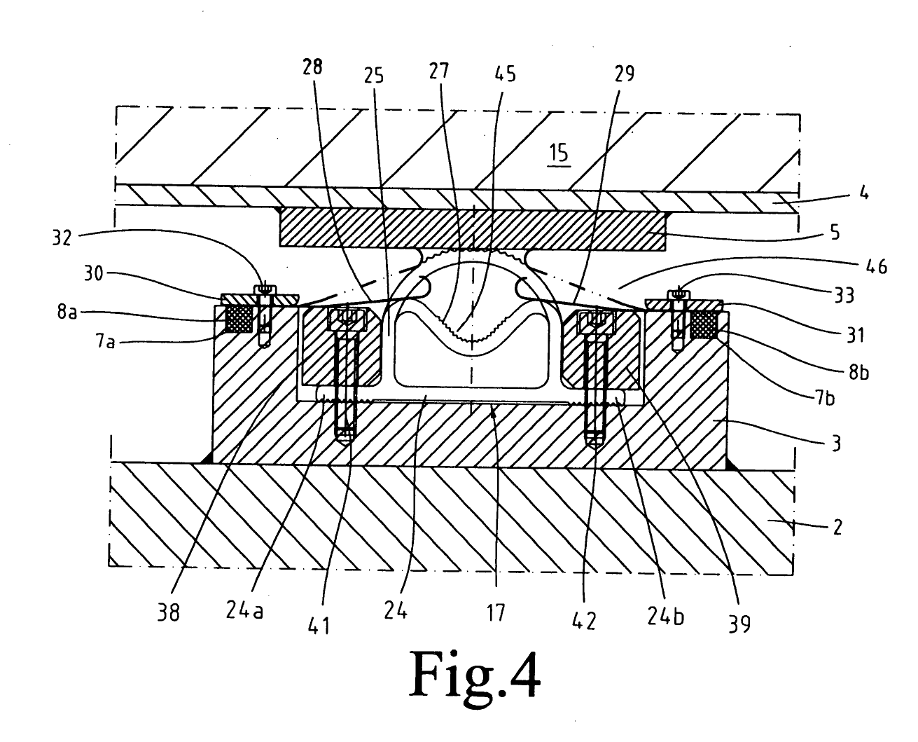

FIG. 4 is a partial view of the arrangement according to the invention of a further embodiment of the seal, in particular for use in a sliding gate;

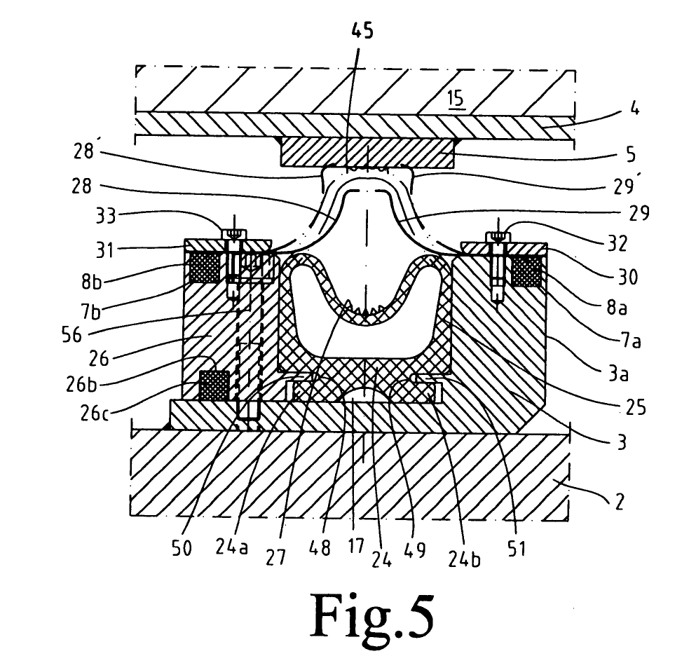

FIG. 5 is a view of a further embodiment of the sealing arrangement according to the invention, in particular for use in a revolving gate; and

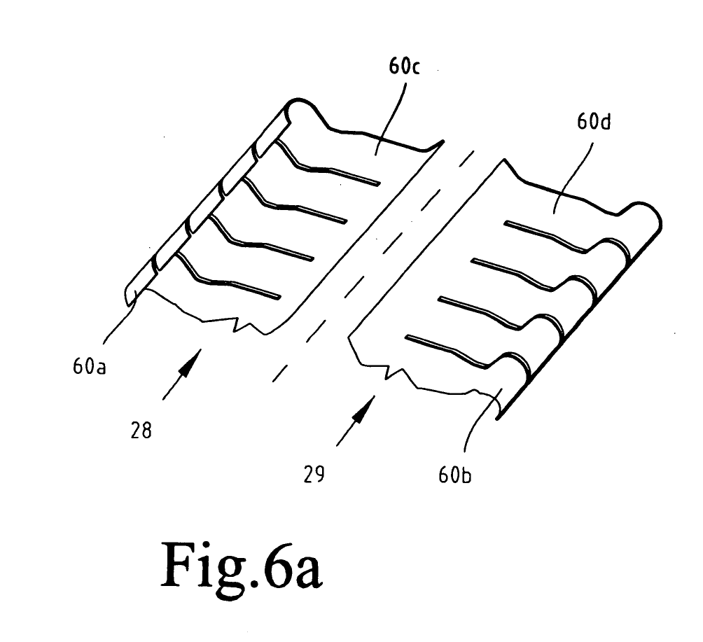

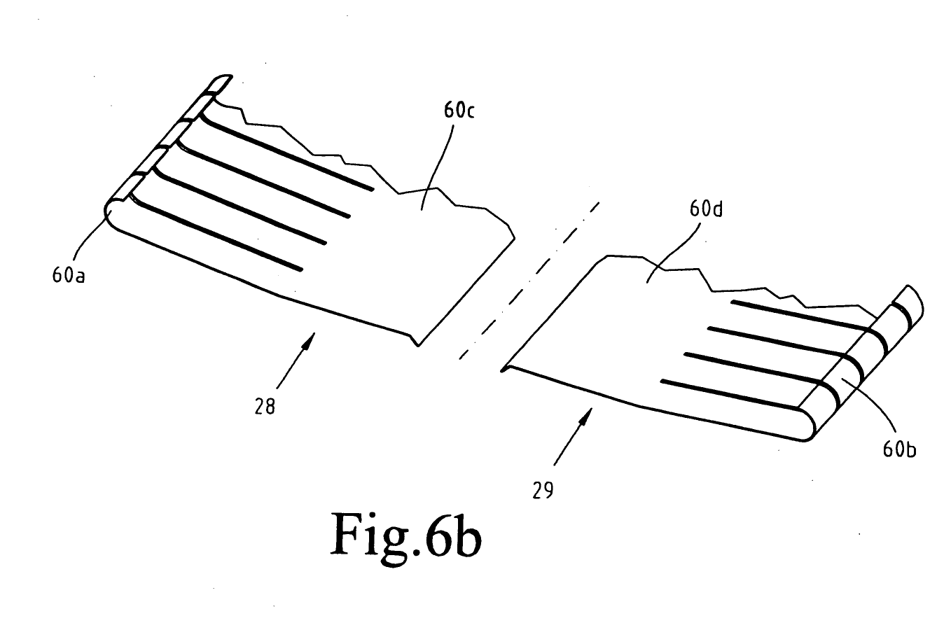

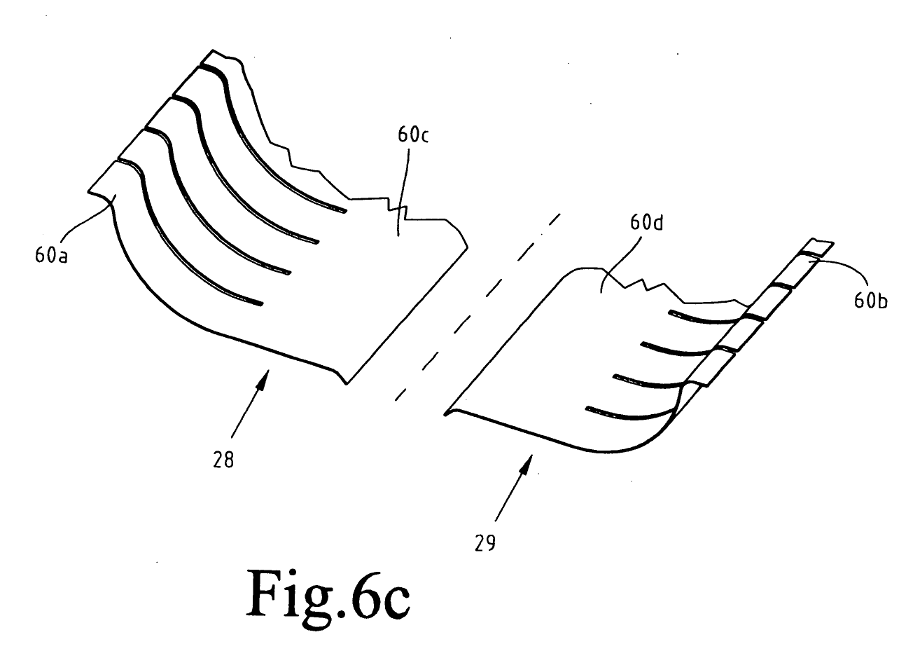

FIGS. 6a, b and c are perspective views of preferred embodiments of spring contact elements.

Various embodiments of a gate according to the invention comprising a pneumatic seal with integrated shielding from electromagnetic radiation will be described hereinafter, shielding in the range of from 3 MHz to 3 GHz preferably being desired.

FIG. 1 shows an arrangement know per se on a revolving gate for shielding from electromagnetic pulses. The arrangement shown in FIG. 1 is provided peripherally on a revolving gate and is provided for abutment against an installation frame which is made from metal or steel and is inserted on the building side. According to the known arrangement, there is provided on the gate denoted by 1, on the side facing the opening in the building, a gate construction 2 comprising a plate or strip 3 which, in proximity to the lateral edges of the gate, is preferably completely peripheral in configuration and is attached to the gate 1 in that position which, when the gate is closed, opposes the building-side installation frame 4.

A corresponding rabbet 5 extending horizontally and/or vertically is attached to the installation frame 4. Two parallel channels 7a, 7b are provided in the strip 3. These channels or grooves 7a, 7b contain lines of electrically conductive fabric 8a, 8b which are electrically contacted using a biased spring 9, the spring 9 being fastened to the strip 3 by screws 10 or the like. The spring 9 may be provided in the form of a spring strip extending over the entire length of the gate. The screwing means 10 fix one or more spring contacts 11, 12 relative to the strip 3 and cause, when the gate is closed, electrical contact between the strip 3, on the one hand, and the rabbet 5 on the building side, on the other hand. Although this arrangement can provide electrical shielding of the opening in the building via the gate, no air-tight seal is produced between the gate and building-side installation frame.

FIG. 2 shows a schematic arrangement for illustrating a gate comprising a pneumatic seal relative to an opening 14 in a building. The walls of the building, shown laterally of the opening 14 in the building, are denoted by 15 and 16. FIG. 2 shows that the gate 1 comprises pneumatic seals 17, 18 associated with the installation frame 4 arranged on both sides of the opening 14 in the building. These seals 17, 18 are provided horizontally and vertically on the upper and lower sides of the gate given a corresponding installation frame in the opening in the building, i.e. if the installation frames of the opening 14 in the building are constructed, in addition to the vertical portions, so as to extend horizontally at the top and bottom. A completely peripheral pneumatic seal 17, 18 in the gate region is obviously preferred.

As may also be seen from FIG. 2, the outer inner face of the building is equipped with an electrically conductive fabric 19, 20 which touches or is in electrical contact with the building-side installation frame via a, for example transverse, end 19a, 20a.

Details of the region denoted by 22 in FIG. 2 will be described hereinafter in greater detail.

FIG. 3 shows a preferred embodiment of an arrangement of the seal in the gate region. The pneumatic seal 17 shown at this location comprises a base 24 which is fixedly integrated into the gate construction 2. In the illustrated embodiment there is provided on the gate construction 2 a plate or strip 3 which is profiled and is adapted to the profile of the seal 17. In the illustrated embodiment, the base 24 has stand or foot portions 24a, 24b which protrude laterally beyond the sealing member 25 itself, the sealing member 25 being a tube-like sealing member. A corresponding groove 3a in the strip 3 receives in FIG. 3 the left-hand stand 24. The strip 3 is attached, preferably welded, to the gate construction 2. On the right-hand side, as shown in FIG. 3, the seal 17 is wedged in that the stand 24b is grasped by a narrow strip 26, wherein the strip 26 may be fastened to the plate 3 by screwing means 56 or the like. The seal 17 is thus fixed within the strip 3 and is closed or encompassed in FIG. 3 laterally toward the right by the strip 26. As may be seen from FIG. 3, the inflatable seal 17 is located, in the non-activated state, within the strip 3 and is overlapped on its sealing surface 27 by preferably two spring contacts 28, 29. As shown in FIG. 3, the spring contacts 28, 29 have a hook-shaped and/or circular arc-shaped end, this spring end extending from the strips 3, 26 toward the centre or axis of the seal 17 in such a way that once the seal 17 has been inflated, the ends are displaced by the surface 27 toward the installation frame 4 and are pressed against the rabbet 5 attached to the installation frame 4, as indicated by the reference numerals 28′ and 29′. One end of the spring contacts 28, 29 is located in an electrically conductive fabric or line of fabric 8a, 8b which is inserted into the grooves 7a, 7b and is electrically conductive. This ensures effective electrical contact closure between the strips and plates 3 and 26 respectively, the lines of fabric 8a, 8b and the spring contacts 28, 29 and thus also electrical contact relative to the rabbet 5 or the installation frame 4 on the building side.

The spring contacts 28, 29 are individual spring elements but preferably spring strips which preferably form in the region of the fabric 8a, 8b a continuous portion, i.e. an uninterrupted strip, whereas slots may be provided in the region of the hook-shaped or circular spring ends, the width of the slots being approximately 1 mm.

Closure strips 30, 31, which are fastened to the strips 3, 26 by screwing means 32, 33 or the like, are used for fastening the spring contact ends inserted into the fabric 7a, 7b. As may be seen from FIG. 3, predetermined portions of the spring contacts 28, 29 are clamped by these closure strips 30, 31 to the fabric 8a, 8b and also to portions 3b, 26a, thus ensuring fixed support of the spring contacts 28, 29.

In order to ensure effective electrical contact between the strip 3 and the strip 26, there is formed on the bottom of the strip 26 a groove 26b into which is inserted an electrically conductive fabric, preferably a line of fabric 32, which ensures effective electrical contact between the plate 3, on the one hand, and the plate 26, on the other hand. The structure of the gate construction 2 shown at the bottom of FIG. 3, i.e. the construction outwardly adjoining the strip from the gate, is dependent on the prevailing conditions and will not be described here in detail.

The embodiment shown in FIG. 3 concerns a revolving door with an inflatable seal 17, the seal shown in FIG. 3, with the plates 3, 26, etc. retaining it, being formed on the inner face of the door, preferably peripherally on four sides. In the inflated state of the seal 17, the seal surface 27 is directly adjacent to the rabbet 5 over a predetermined region. In order to produce a very high degree of air-tight closure, the seal 17 is profiled in its construction, i.e. provided with lips or ribs preferably extending in the axial direction of the seal 17, at least in the region of the surface 27, as is indicated in detail in FIG. 4.

In the inflated state of the seal 17, the central region of the surface 27 therefore presses against the rabbet 5, whereas the spring contacts 28, 29, which are bent over at their hook-shaped or circular ends, are clamped between the surface 27 and the face of the rabbet 5 and produce an electrical contact between the strip 3 or 30, on the one hand, and the rabbet 5, on the other hand. The fact that the plates 3 are welded at 35, 36 to the remainder of the door construction 2, which is made from metal, produces over the entire width of the gate shown in FIG. 2 a shielding effect which is effective over the spring contacts 28, 29 up to the walls of the building, with the fabric 19, 20 provided at this location, i.e. beyond the opening in the building, around the entire building.

In order not to provide any weak point for an external attack, the arrangement shown in FIG. 3 is integrated into the gate in such a way that the strip 26 of the seal 17 is constructed toward the centre of the door, that is, from the narrow side of the gate or the gate edge, each strip 3, with the strip 30 located thereabove, is directed outward. As FIG. 2 shows, the installation frame 4 is electrically connected to the fabric 19 in the region of the fabric end portion 19a. The rabbet 5 is preferably welded to the installation frame 4, so there is effective electrical contact between the fabric 19 and the rabbet 5.

The construction shown in FIG. 3 is advantageously suitable for use in a revolving door.

FIG. 4 shows an embodiment, modified compared to FIG. 3, of a gate with a seal 17. As in FIG. 3, the seal is shown both in the non-blown-up or non-inflated state and in the inflated state, the lips or ribs formed on the surface 27 not being shown in the inflated state. In principle, the configuration according to FIG. 4 corresponds to that described in conjunction with FIG. 3. In contrast to FIG. 3, the seal 17 comprises two laterally extended foot portions 24a, 24b which extend outward from the base 24 over a greater distance than in the embodiment according to FIG. 3. In the embodiment according to FIG. 3, the foot portions 24a, 24b are less tall but have a greater arm length or greater width and are clamped to the plate or strip 3 by clamping strips 38, 39.

Screwing means 41, 42 or the like, which pass through the clamping strips 38, 39 and engage with corresponding threads in the strip 3, are provided for fastening the clamping strips 38, 39 to the plate 3. In the non-inflated state of the seal 17, the spring contacts 28, 29 are located almost in a plane defined by the upper face of the strip 3 or by the clamping strips 30, 31, the hook-shaped or rounded ends of the spring contacts 11, 12 being located within the folded-in belly of the seal 17, i.e. they protrude, albeit only slightly, beyond the seal 17 in its non-inflated state in order not to protrude, or not to protrude too far, from the gate during the revolving process on movement of a revolving gate. Damage to the spring contacts is thus prevented.

In the inflated state of the seal 17 and when the gate is closed, the seal presses the bent-down ends of the spring contacts 11, 12 against the rabbet 5. FIG. 4 is a schematic illustration of a state in which the seal has not yet been completely inflated. In the completely inflated state, air-tight closure is produced between the seal 17 and the rabbet 5, as described and explained in conjunction with FIG. 3. In the completely inflated state, the lips or ribs indicated in FIG. 4 by reference numeral 45 therefore rest, at least over part of their overall surface area, against the surface of the rabbet 5, in the gap provided for the seal between the bent-over ends of the springs 28, 29.

According to FIG. 4, the clamping strips 38, 39 are located together with the seal 17 in a substantially U-shaped recessed region 46 of the seal 3, i.e. within a groove, the width of which corresponds to the overall width formed by the seal and clamping strips 38, 39. In this embodiment, the clamping strips 38, 39 may be arranged close to the lateral arms of the U-shaped recess 46 without thereby impairing the effectiveness of the seal 17. The spring contacts 11, 12 reach from the groove 7a, 7b into which is inserted an electrically conductive fabric 8a, 8b, substantially toward the centre of the seal 17, thus covering the clamping strips 38, 39 before the spring contacts 11, 12 merge with the hook-shaped or circular end portions.

As described with reference to the embodiment according to FIG. 3, the strip 3 is rigidly connected, preferably welded, to the remainder of the door construction 2.

FIG. 5 is a partial cross-section of a further variation of a gate with a pneumatic seal, preferably for use in a revolving gate. This embodiment is preferably used in a revolving gate. In the embodiment shown in FIG. 5, the seal 17 preferably also extends peripherally on the inner face of the gate. Identical parts are provided with the same reference numerals as in FIG. 3 and FIG. 4 and will not be described again.

The embodiment according to FIG. 5 is in principle similar to the embodiment according to FIG. 3, i.e. the seal 17 is enclosed by the surrounding wall regions. According to FIG. 5, the seal 17 is provided with foot portions 24a, 24b which are set apart from the sealing member which extends upward in FIG. 5, i.e. a slot 48, 49 of predetermined width extending in the axial direction of the seal 17 is located between the foot portion 24a, 24b and the sealing member 25. Ribs 50, 51 engage with these slots 48, 49. The rib 51 is provided as a projection protruding from the strip 3, whereas the rib 50 is in the form of a projection protruding from the clamping strip 26. The ribs 50, 51 extend in a plane parallel to the door construction 2.

The embodiment according to FIG. 5 therefore basically applies the principle according to FIG. 3, i.e. the seal 17 is fixed by the plate 3, on the one hand, and the strip 26, on the other hand, in that corresponding projections support the foot portions 24a, 24b. FIG. 5 shows both the state of the non-inflated seal 17 and, in broken lines, the state of the seal to be inflated. In the inflated state, ribs or channels 45 on the surface denoted by 27′ press tightly against the rabbet 5, thus producing an air-tight seal. At the same time, the seal 17 presses the spring contacts 28, 29 upward into electrical contact with the rabbet 5. The fastening of the spring contacts 28, 29 corresponds to the method described in conjunction with FIG. 3, i.e. they are in electrical contact with a metallically conductive fabric 8a, 8b and are fastened to the strip 3 or 26 by clamping plates 30, 31. As in the embodiments according to FIGS. 3 and 4, the end of each spring contact 28, 29 remote from the lip 17 is introduced or inserted directly into the fabric 8a, 8b or at least partially penetrates the fabric 8a, 8b, thus ensuring outstanding electrical contact therebetween.

As in the embodiment according to FIG. 3, the strip 26 is fastened to the strip 3 by screwing means 27 and in this arrangement too, which is preferably used in a revolving gate, the outer face denoted by 3a is directed toward the outer edge of the door, whereas the strip 26 is arranged toward the centre of the door. The fabric in the groove 26b is denoted by 26c and causes, as in the embodiment according to FIG. 3, electrical contact between the clamping strip 26, on the one hand, and the strip 3, on the other hand.

In the embodiment shown in FIG. 5, the base 24 of the seal 17 is curved in the axial direction on the downward-directed face, thus allowing material to be saved compared to the embodiment according to FIG. 3. However, also as in FIG. 3, the base 24 may be constructed as a substantially rectangular element. The main thing is that the ribs 50, 51 grasp the seal 17 through their slots 48, 49 and fix it in position. The seal 17 is fitted in such a way that the seal 17, as in the embodiment according to FIG. 3, is applied to the plate 3 and is attached to the plate to the extent that the projection or rib 51 is inserted into the lateral slotted recess 49, after which the clamping strip 26 is accordingly moved laterally toward the seal 17 until the rib 48 engages with the recess 50. The clamping strip 26 is then fastened to the strip 3 by the screwing means 56. Finally, the spring contacts 28, 29 are fastened to the strip 26 or 3 by screwing means 33 or 32 in the manner shown in FIG. 5, using the clamping strips 30, 31,

The invention relates to revolving doors, sliding gates and revolving gates comprising pneumatic seals. Gates of this type have a weight of between 150 and 400 tonnes. The seals 17, which are loaded with a sealing pressure of between 0.1 and 0.5 bar, are accordingly designed by size. In gates of this type, the seals 17 have a height of from approximately 20 to 50 mm and a width of approximately 50 mm, although their dimensions may be varied accordingly.

The spring contacts used in the above-described sealing arrangements have a continuous portion which extends parallel to the clamping strips 30, 31 and to which the spring tongues are connected in the direction of the sealing member 27. The spring tongues preferably have a width of 6 mm, i.e. adjacent spring tongues are separated by slots having a width of, for example, 1 mm.

The fabrics used in the sealing arrangements preferably consist of copper. EMC seals in the form of lines of fabric having dimensions of 10×10 mm are preferably used.

The material of the spring contacts preferably consists of CuBr.

In the embodiments according to FIGS. 3 and 5, the strip 3 for receiving the seal 17 has a lateral substantially L-shaped recess for receiving the seal 17 and the clamping strip 26, the clamping strip 26 closing this recess laterally and relative to the receiving strip 3.

In the above-described embodiments, the spring contacts 28, 29 are provided so as to extend from two sides toward the centre of the seal 17. The hook-shaped end portions of the spring contacts 28, 29 preferably end not only at a distance from one another but also at a distance from the centre line of the seal 17 in order to ensure defined erection of the spring contact ends toward the rabbet 5, i.e. in the inflated state of the seal 17 the erected spring contact ends should remain set apart by a distance such that the surface 27 of the seal 17 is able to press in an air-tight manner against the associated face of the rabbet 5.

It is clear from the foregoing embodiments that both the seal 17 and the electrical spring contacts 28, 29 located above the seal 17 are preferably formed completely peripherally on the inner face of the gate.

FIGS. 6a to 6c show examples of spring contacts 28, 29 which have no slots over a first region denoted by 60c and 60d while being slotted in the region of the spring contact ends denoted by 60a and 60b. The slot width, which in a preferred embodiment is 1 mm, depends on the frequency of the electromagnetic waves and/or pulses from which shielding is required and is optionally altered accordingly. The width of the spring tongues defined by the slots is preferably 5 mm.

FIG. 6a shows a pair of spring contacts 28, 29 which are preferably suitable for use in a revolving gate comprising a seal according to FIG. 3; FIG. 6b illustrates a pair of springs which are preferably used in a sliding gate comprising a seal according to FIG. 4, whereas FIG. 6c illustrates a pair of springs which are preferably used in a revolving gate comprising a seal according to FIG. 5. Identical reference numerals denote identical parts.

1. Door or gate, with an at least partially peripheral sealing means (17), with a retaining strip (3) made from metal, within which the seal (17) is arranged, wherein the seal (17) may be activated pneumatically and is provided in the region of a door or gate opening (14) for air-tight abutment against an installation frame (4) made from metal, with fastening means (30, 31) arranged laterally of the seal (17) for fastening electrically conductive contact elements (28, 29), the electrical contact elements (28, 29) extending in the direction of the longitudinal axis of the seal (17) and with their end above the surface (27) of the seal (17) that is directed toward the door or gate opening (14) in such a way that when the door/gate is closed, said contact elements are pressed into electrical contact with the building-side installation frame (4) and the surface (27) of the seal (17) is at the same time in air-tight contact with the installation frame (4).

2. Door or gate according to claim 1, characterised in that the seal (17) has a base (24) with foot portions (24a, 24b) which extend laterally away from the base (24) and are clamped to the retaining strip (3).

3. Door or gate according to claim 1, characterised in that the electrical contact elements (28, 29) comprise the spring contact strips fastened on both sides of the seal (17).

4. Door or gate according to claim 1 characterised in that the retaining strip (3) comprises an L-shaped recess and a clamping strip (26) which is fastened to said L-shaped recess so as to enclose the seal (17).

5. Door or gate according to claims 1, characterised in that the retaining strip (3) comprises a substantially U-shaped groove (46) into which the seal (17) is inserted wherein said seal is enclosed by clamping strips (38, 39).

6. Door or gate according to claim 1, characterised in that the retaining strip (3) comprises a clamping strip (26), wherein said retaining strip and clamping strip are provided with grooves (7a, 7b) formed in the surface of said strips and in that the grooves (7a, 7b) are provided with an electrically conductive fabric (8a, 8b) into which ends of the spring contacts (28, 29) are pressed.

7. Door or gate, with an at least partially peripheral sealing means (17), with a retaining strip (3) made from metal, within which the seal (17) is arranged, wherein the seal (17) may be activated pneumatically and is provided in the region of a door or gate opening (14) for air-tight abutment against an installation frame (4) made from metal, with fastening means (30, 31) arranged laterally of the seal (17) for fastening electrically conductive contact elements (28, 29), the electrical contact elements (28, 29) extending in the direction of the longitudinal axis of the seal (17) and with their end above the surface (27) of the seal (17) that is directed toward the door or gate opening (14) in such a way that when the door/gate is closed, said contact elements are pressed into electrical contact with the building-side installation frame (4) and the surface (27) of the seal (17) is at the same time in air-tight contact with the installation frame (4), wherein the retaining strip (3) comprises a clamping strip (26), wherein said retaining strip and clamping strip are provided with grooves (7a, 7b) formed in the surface of said strips and in that the grooves (7a, 7b) are provided with an electrically conductive fabric (8a, 8b) into which ends of the spring contacts (28, 29) are pressed and wherein the grooves (7a, 7b) are covered by strips (30, 31) so as to enclose the spring contacts (28, 29).

8. Gate or door according to claim 1, characterised in that the spring contacts (28, 29) have hook-shaped or circular bent-over ends, which are arranged above the adjustable face (27) of the seal (17).

9. Door or gate, with an at least partially peripheral sealing means (17), with a retaining strip (3) made from metal, within which the seal (17) is arranged, wherein the seal (17) may be activated pneumatically and is provided in the region of a door or gate opening (14) for air-tight abutment against an installation frame (4) made from metal, with fastening means (30, 31) arranged laterally of the seal (17) for fastening electrically conductive contact elements (28, 29), the electrical contact elements (28, 29) extending in the direction of the longitudinal axis of the seal (17) and with their end above the surface (27) of the seal (17) that is directed toward the door or gate opening (14) in such a way that when the door/gate is closed, said contact elements are pressed into electrical contact with the building-side installation frame (4) and the surface (27) of the seal (17) is at the same time in air-tight contact with the installation frame (4), wherein the retaining strip (3) comprises a clamping strip (26), wherein said retaining strip and clamping strip are provided with grooves (7a, 7b) formed in the surface of said strips and in that the grooves (7a, 7b) are provided with an electrically conductive fabric (8a, 8b) into which ends of the spring contacts (28, 29) are pressed and wherein the grooves (7a, 7b) are covered by strips (30, 31) so as to enclose the spring contacts (28, 29), wherein the spring contacts (28, 29) have hook-shaped or circular bent-over ends, which are arranged above the adjustable face (27) of the seal (17).

10. Door or gate according to claim 1, characterised in that the retaining strip comprises a clamping strip (26), to be fastened to the retaining strip (3), wherein said clamping strip comprises a groove (26b) which is directed toward the retaining strip (3) and into which there an electrically conductive fabric (26c) is inserted which may be brought into contact with the strip (3).

11. Door or gate according to claim 1, characterised in that the surface of said seal is adjustable and provided on its surface with ribs, channels or teeth.

12. Door or gate according to claim 1, characterised in that the seal (17) is fastened to the retaining strip (3) by clamping strips (38, 39).

13. Door or gate according to claim 1, characterised in that the seal (17) comprises foot portions, said seal being provided with lateral grooves or slots (48, 49) which extend in the axial direction of the seal and which are provided above the foot portions (24a, 24b), wherein further the retaining strip (3) and the clamping strip (26) are provided with ribs or projections (48, 49) which engage with the grooves (49, 50) of the seal (17).

14. Door or gate, with an at least partially peripheral sealing means (17), with a retaining strip (3) made from metal, within which the seal (17) is arranged, wherein the seal (17) may be activated pneumatically and is provided in the region of a door or gate opening (14) for air-tight abutment against an installation frame (4) made from metal, with fastening means (30, 31) arranged laterally of the seal (17) for fastening electrically conductive contact elements (28, 29), the electrical contact elements (28, 29) extending in the direction of the longitudinal axis of the seal (17) and with their end above the surface (27) of the seal (17) that is directed toward the door or gate opening (14) in such a way that when the door/gate is closed, said contact elements are pressed into electrical contact with the building-side installation frame (4) and the surface (27) of the seal (17) is at the same time in air-tight contact with the installation frame (4), wherein the seal (17) comprises foot portions, said seal being provided with lateral grooves or slots (48, 49) which extend in the axial direction of the seal and which are provided above the foot portions (24a, 24b), wherein further the retaining strip (3) and the clamping strip (26) are provided with ribs or projections (48, 49) which engage with the grooves (49, 50) of the seal (17) and wherein further the retaining strip (3) and the clamping strip (26) are provided with ribs or projections (48, 49) which engage with the grooves (49, 50) of the seal (17), and wherein the clamping strip (26) is provided so as to face the centre of the door or the gate.

15. Door or gate according to claim 1, characterised in that the spring contacts (28, 29) consist of a continuous strip extending substantially below said fastening means which is formed by clamping strips (30, 31) whereas the tongues of the spring contacts (28, 29), which are arranged above the seal (17), are provided with slots.

16. Door or gate, with an at least partially peripheral sealing means (17), with a retaining strip (3) made from metal, within which the seal (17) is arranged, wherein the seal (17) may be activated pneumatically and is provided in the region of a door or gate opening (14) for air-tight abutment against an installation frame (4) made from metal, with fastening means (30, 31) arranged laterally of the seal (17) for fastening electrically conductive contact elements (28, 29), the electrical contact elements (28, 29) extending in the direction of the longitudinal axis of the seal (17) and with their end above the surface (27) of the seal (17) that is directed toward the door or gate opening (14) in such a way that when the door/gate is closed, said contact elements are pressed into electrical contact with the building-side installation frame (4) and the surface (27) of the seal (17) is at the same time in air-tight contact with the installation frame (4), wherein the spring contacts (28, 29) have hook-shaped or circular bent-over ends, which are arranged above the adjustable face (27) of the seal (17), and wherein said hook-shaped or bent ends of the spring contacts (28, 29) are set apart from a centre line of the seal (17) and from one another.

17. Door or gate according to claim 1, characterised in that the contact elements are formed by spring contacts (28, 29) which are slotted, at least in part, transversely to the longitudinal axis of the seal (17).

18. Pneumatic seal for doors or gates, in particular revolving or sliding gates and revolving doors, with a strip (3) for receiving a pneumatically actuatable sealing element (17) with grooves (7a, 7b) formed in the strip (3) laterally of the sealing element (17) for receiving-electrically conductive fabric (8a, 8h) and with clamping strips (30, 31) arranged laterally of the sealing element (17) for fixing spring contacts (28, 29), the free ends of which are arranged above the sealing element.

19. Seal according to claim 18, characterised in that the sealing element (17) comprises foot portions (24a, 24b) which are overlapped by stand portions of the strip (3).

20. Seal according to claim 18, characterised in that the sealing element comprises slots which extend substantially parallel to the base (24) and with which the ribs (48, 49) of the strip (3) engage.

21. Seal according to claim 18, characterised in that the strip (3) comprises clamping strips (38, 39) which are fastened by screwing means (41, 42) and wherein the sealing element comprises foot portions which are supported by said clamping strips.
